(19) United States
(12) Patent Application Publication
(10) Pub. No.: US 2025/0292633 A1
(43) Pub. Date: Sep. 18, 2025

(54) Method and Device for Evaluating a Quality of an Automated Function of a Motor Vehicle

(71) Applicant: Bayerische Motoren Werke Aktiengesellschaft, Muenchen (DE)

(72) Inventors: Marco BAUMGARTL, Gilching (DE); Christian UNGER, Maisach (DE)

(21) Appl. No.: 18/862,924

(22) PCT Filed: Mar. 28, 2023
(86) PCT No.: PCT/EP2023/057934

§ 371 Date: Nov. 4, 2024

(30) Foreign Application Priority Data
May 5, 2022 (DE) 10 2022 111 181.4

(51) Int. Cl. G07C 5/08

(52) U.S. Cl. CPC G07C 5/0808; G07C 5/0841

(57) ABSTRACT

A method for evaluating a quality of an automated function of a motor vehicle includes providing at least one self-analysis function as a software module for the automated function. The method further includes determining a predefined variable based on input data and/or output data of the automated function by means of the self-analysis function. The method further includes transmitting the predefined variable from the motor vehicle to a backend system.

### BACKGROUND AND SUMMARY

The present disclosure relates to a method for evaluating a quality of an automated function of a motor vehicle. In addition or as an alternative, a data processing apparatus or a system for data processing which is designed to execute at least part of the method is provided. In addition or as an alternative, an (optionally automated) motor vehicle is provided with a part of the data processing apparatus. In addition or as an alternative, a computer program which comprises commands which, when the program is executed by a computer, cause said computer to execute at least part of the method is provided. In addition or as an alternative, a computer-readable medium which comprises commands which, when the commands are executed by a computer, cause said computer to execute at least part of the method is provided.

Data or information from (customer) vehicles can be transmitted via mobile data connections to a backend or a cloud in order to collect and analyze data there. Existing data interfaces are usually tapped off for this purpose and the data are sent via stream or in a buffered manner. In this case, only few signals are sent at a low frequency for reasons of cost.

Typical signals which are provided for the up-stream are items of availability information of customer functions or automated functions (or automated systems) or items of information about whether and at what position the customer has activated (or deactivated) such a function, or where a problem with such a function has arisen. This information permits analyses of existing functions, and specifically in a manner restricted to situations in which the functions are active or activatable according to their ODD (operational design domain).

The ODD can be understood as meaning a description or setting of specific operating ranges in which an automated function or an automated system is intended to function as intended, including but not limited to road types, speed ranges, environmental conditions (weather, date/night, etc.) and/or other limitations of the operating ranges. In other words, the ODD can be understood as meaning the specific conditions under which a particular driving automation system or a function thereof is intended to function, including but not limited to driving modes. This may include a plurality of limitations, such as for example geographic, traffic-related, speed-related and/or road-related limitations.

However, novel functions or functions outside of the ODD cannot be analyzed because the analysis capability is coupled to an activation or activation ability of the function.

Against the background of this prior art, the object of the present disclosure is to specify an apparatus and method which are each suitable for enhancing the prior art.

The object is achieved by the features of the independent claim. The content of the coordinate claims and dependent claims are possible developments of the disclosure.

The object is accordingly achieved by a method for evaluating a quality of an automated function of a motor vehicle.

The quality can be understood as meaning an objective variable or an objective measure for a functionality, or a quality of an automated function of the motor vehicle, in particular of a subsystem of such a function (for example a fusion) or an SW module thereof.

The method may be a computer-implemented method, that is to say a computer or a data processing apparatus can be used to carry out one, multiple or all steps of the method.

The automated function can be understood as meaning a function or a (software and/or hardware) module which undertakes one or more predefined tasks in the motor vehicle in an automated manner or without human input. In this case, the automated function may be part of or constitute a driving assistance system. Examples of an automated function include object identification, trajectory planning and/or direct and/or indirect intervention or direct and/or indirect control of a transverse and/or longitudinal guidance of the motor vehicle.

The method comprises providing at least one self-analysis function as a software module for the automated function.

The method comprises determining a predefined variable based on input data and/or output data of the automated function by means of the self-analysis function.

In other words, an algorithm, the so-called self-analysis function, is used to determine a variable or a piece of information which is set by a configuration of the algorithm. It is thus not a value of the variable or the item of information that is predefined, but the variable to be determined is predefined. In this case, it is possible to set in the respective algorithm which signal or which data stream is to be tapped off in the motor vehicle and how the tapped signal is to be analyzed in order to obtain the variable (predefined thereby).

The method comprises transmitting the (determined) predefined variable from the motor vehicle to a backend.

The variable can be sent or transmitted wirelessly, for example via the Internet and/or the mobile radio network. The variable can be transmitted and the method can be executed continuously, in particular cyclically or continually. The transmission can then also be referred to as streaming (what is known as up-stream).

In other words, customer functions or automated functions are usually composed of many modules, such as for example object identification, road identification, trajectory planner, etc. It is proposed to extend existing modules or modules already present in the motor vehicle (for example an identification function such as object identification) with a self-analysis function or “self-assessment” functionalities. The aim thereof is to determine characteristic values (within the identification of the so-called predefined variable) which make it possible to assess the quality of the module.

The method can be used to analyze function extensions and risks based on the self-assessment or self-analysis of on-board algorithms. This makes it possible to evaluate and ultimately implement new automated functions and/or ODD extensions of existing automated functions.

New functions can build on existing modules when signals or information provided for and/or by automated functions already installed in the motor vehicle are used in a novel way (for example a specific new reaction to pedestrians exhibiting a particular behavior pattern who have been identified using existing automated functions). Since the new automated function does not exist in the vehicle, it cannot be evaluated across the vehicle fleet by conventional means. It is possible, however, to use the method described above to evaluate the extent to which the modules on which the new automated function is based to provide signals or information with a quality sufficient for the new automated function (for example is the pedestrian identification sufficiently good to be able to identify the specific behavior pattern?). In this case, it is possible to gain an understanding of whether these signals are available with the required quality for example extensively or with particular limitations (depending on situations, location, etc.).

As mentioned above, ODD extensions to existing automated functions are also possible using the method. ODDs are limited specifically in terms of the functional design with the expectation that an automated function cannot be provided with a sufficient quality in particular situations (for example an automated function aimed at objects is not offered on small roads depending on the road type because objects which are particularly difficult to identify are to be expected with such road types and the sensor system installed cannot acceptably achieve this). If the desire is to evaluate whether a function can be operated outside of the nominal ODD thereof or which measures would be necessary to extend the ODD thereof, an evaluation of the behavior of the individual functional modules in the ODD ranges to be examined is necessary and this is possible by means of the method described above through a suitable definition of the predefined variables or data or information to be determined by the self-analysis function.

The method described above is explained in more detail below with reference to possible developments.

The predefined variable may be an uncertainty in the case of an association of an object identified by means of a sensor of the motor vehicle with an object track, a frequency of a change of hypothesis in the case of unclear detection of an object identified by means of a sensor of the motor vehicle, a frequency of a change of class of an object identified by means of a sensor of the motor vehicle, and/or an a posteriori measure for an incorrect detection of an object identified by means of a sensor of the motor vehicle.

In other words, use may be of a measure of the uncertainty/ambiguity in the case of an association of sensor objects with object tracks, a measure for the frequency of a change of hypothesis in the case of unclear sensor detections, a measure for the frequency of changes of ID of tracked entities, and/or an a posteriori measure for incorrect detections (for example how often have objects in the long-distance range been incorrectly classified but were identifiable only through observation after an approach in the near-field range).

The method may comprise providing a plurality of self-analysis functions in each case as a software module for the automated function, determining a respective predefined variable based on the input data and/or the output data of the automated function by means of the self-analysis functions, determining a data vector from the predefined variables determined by means of the self-analysis functions, and transmitting the data vector from the motor vehicle to the backend.

The method may comprise determining a position of the motor vehicle at which the predefined variable is determined, and transmitting the determined position, together with the predefined variable, from the motor vehicle to the backend.

The method may comprise creating a digital map based on the transmitted predefined variable and the position transmitted together with the predefined variable in the backend. The digital map may then include description for example of expected functional limitations, risks etc. at particular geo-locations or at particular points, sections and/or in particular regions of the digital map.

The method may comprise carrying out the method described above multiple times in order to obtain in the backend multiple predefined variables or multiple data vectors which are determined that the same position of the motor vehicle and/or in the same driving situation. The method may also comprise aggregating the multiple predefined variables or the multiple data vectors in the backend, wherein the digital map is created based on the aggregated multiple predefined variables or the multiple data vectors.

The digital map may furthermore be created based on an availability of the automated function at the respective position of the motor vehicle and/or a piece of information about an ODD range of the automated function. The digital map may then obtain information about the availability of the automated function at particular geo-locations or at particular points, sections and/or in particular regions of the digital map.

In other words and in relation to a specific configuration which is described as non-limiting for the present disclosure, the description given above can be summarized as follows: a plurality of such “self-assessment” functionalities can be operated and a resulting data vector can be streamed to a data backend for example via a permanent up channel. A map which illustrates the data vectors, aggregated by many customer or developer fleet vehicles, together with function ODD ranges and information relating to customer function availability, can be created there. This results-inter alia-in the following possibilities: the correlation between the “self-assessment” vectors and customer function behavior can be evaluated. For example, increased ambiguities in the object identification can be correlated with incorrect braking operations in response to objects. In addition or as an alternative, risky locations and situations can be identified, in which the “self-assessment” vectors indicate a poor or incorrect response which, however, did not lead to losses of function in some circumstances. For example, in narrow single-lane bends, an ID change of tracked lanes can frequently be observed, but these never led to objections in tests because no errors were made when the lane was being set up from new due it being a single lane. This was used to identify a risk which could be relevant to multi-lane narrow bends, with the risk being able to be quantified and evaluated using fleet data. In addition or as an alternative, it is possible to identify opportunity-filled locations and situations in which the “self-assessment” vectors indicate a sufficiently good response in order to operate existing functions outside of the ODD thereof or to provide new functions. As an example of this, it is possible to consider a function which is based on good object identification but was never enabled for small road types. The data can show that the identification quality is actually sufficient to expand the function to include these small road types as well. In addition or as an alternative, logic conditions can be produced from the linking of “self-assessment” vectors. These logics can be supplied to the on-board system by way of a down channel (that is to say from the backend to the motor vehicle) within specific data collection campaigns. The on-board system produces trigger conditions therefrom, which initiate an upload of particular (or all available) sensor data in a period of time before and/or after the trigger event. These data can then be thoroughly analyzed in the backend in order to analyze for example the reasons for losses of quality in identification functions in a specific context. An example of this may be a driving function which in rare cases exhibits errors in roundabouts. It may then be clear from the “self-assessment” vectors that these cases correlate to abnormalities in the case of lane ID changes, increased uncertainty in object identification and slow oncoming traffic. The combination of these three elements of the “self-assessment” vectors (ID change, uncertainty, oncoming traffic speed), together with the location information “on a roundabout”, is supplied to the on-board system as a trigger condition. Data from the field with these specific abnormalities can thus be collected and analyzed, and improvements in the form of software updates can be derived.

A system for data processing, comprising means for executing the computer-implemented method described above, is also provided.

The system may be a distributed system which may comprise an external (to the motor vehicle) data processing apparatus (that is to say the backend) which is operated for example by the motor vehicle manufacturer, and/or may comprise a data processing apparatus connected thereto (in particular wirelessly) and arranged in or on the motor vehicle.

The latter data processing apparatus may thus be part of a motor vehicle. The data processing apparatus of the motor vehicle may be for example a data logger and/or an electronic control unit (ECU). The data processing apparatus of the motor vehicle may be an intelligent processor-controlled unit which can communicate with other modules for example via a central gateway (CGW) and which can form the on-board vehicle system where appropriate via field buses, such as the CAN bus, LIN bus, MOST bus and FlexRay or via automotive ethernet, for example together with telematics controllers. The data processing apparatus may be connected to form a sensor system, for example by means of the aforementioned on-board system.

It is conceivable that the data processing apparatus comprises a memory unit in which collected data and/or the determined variable(s) are buffer-stored before they are sent to the external data processing apparatus. It is conceivable that the data processing apparatus sends, in particular streams (optionally without buffer storage), the collected data to the data processing apparatus operated by the motor vehicle manufacturer.

The description given above in relation to the method also applies similarly to the system for data processing and vice versa.

A motor vehicle having a data processing apparatus can also be provided, wherein the data processing apparatus is designed to execute the method for evaluating the quality of the automated function of the motor vehicle, the method comprising: determining a predefined variable based on input data and/or output data of the automated function by means of a self-analysis function, and transmitting the predefined variable from the motor vehicle to the backend.

The motor vehicle may be a passenger motor vehicle, in particular an automobile. The motor vehicle may be an automated motor vehicle which may be configured to at least partially and/or occasionally undertake lateral and/or longitudinal guidance during automated driving of the motor vehicle. Automated driving can be carried out in such a manner that the motor vehicle is moved (largely) autonomously.

The motor vehicle may be a motor vehicle of autonomy level 0, that is to say the driver undertakes the dynamic driving task, even if supporting systems (for example ABS or ESP) are available.

The motor vehicle may be a motor vehicle of autonomy level 1, that is to say may have certain driver assistance systems which assist the driver when operating the vehicle, for example adaptive cruise control (ACC).

The motor vehicle may be a motor vehicle of autonomy level 2, that is to say may be partially automated such that functions, such as automatic parking, lane keeping or lateral guidance, general longitudinal guidance, acceleration and/or braking, are undertaken by driver assistance systems.

The motor vehicle may be a motor vehicle of autonomy level 3, that is to say conditionally automated such that the driver does not constantly need to monitor the vehicle system. The motor vehicle independently carries out functions such as operating the turn signal, changing lanes and/or lane keeping. The driver can attend to other things but if necessary is prompted by the system to take control within an advance warning time.

The motor vehicle may be a motor vehicle of autonomy level 4, that is to say highly automated such that the vehicle is permanently controlled by the vehicle system. If the driving tasks are no longer managed by the system, the driver may be prompted to take control.

The motor vehicle may be a motor vehicle of autonomy level 5, that is to say fully automated such that the driver is not needed to perform the driving task. Apart from stipulating the destination and starting the system, no human intervention is needed.

The description given above with respect to the method and the system for data processing also similarly applies to the motor vehicle and vice versa.

A computer program can also be provided. The computer program is characterized in that it comprises commands which, when the program is executed by a computer, cause said computer to execute at least some of the method described above.

A program code of the computer program may be present in any code, in particular in a code suitable for controlling motor vehicles, for example comprising Lua scripts.

A computer-readable medium, in particular a computer-readable storage medium, is provided. The computer-readable medium is characterized in that it comprises these commands which, when the program is executed by a computer, cause said computer to execute at least some of the method described above.

That is to say a computer-readable medium comprising a computer program defined above can be provided. The computer-readable medium may be any digital data storage unit, such as for example a USB stick, a hard disk, a CD-ROM, an SD card or an SSD card.

The computer program does not necessarily have to be stored on such a computer-readable storage medium in order to be made available to the motor vehicle, but it may also be obtained via the Internet or in another external manner.

The description given above in relation to the method, the system for data processing and the motor vehicle also similarly applies to the computer program and the computer-readable medium and vice versa.

At least one embodiment is described below with reference to the Figures.

### BRIEF DESCRIPTION OF THE DRAWINGS

FIG. 1 schematically shows a system for data processing, comprising means for executing a method for evaluating a quality of an automated function of a motor vehicle, and

FIG. 2 schematically shows a flowchart of the method.

### DETAILED DESCRIPTION OF THE DRAWINGS

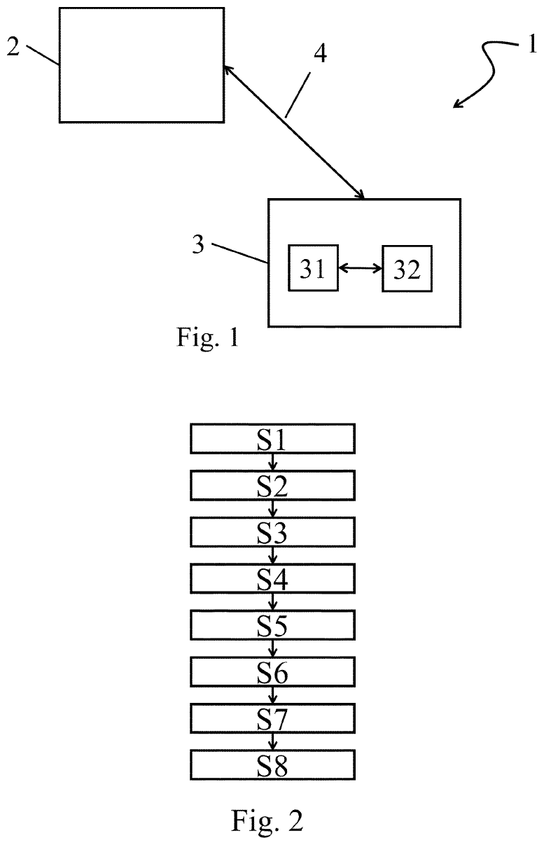

The system 1 illustrated in FIG. 1 has a backend 2 and a motor vehicle 3 connected to the backend via a wireless data connection 4. The motor vehicle 3 has a data processing apparatus 31 and a module connected thereto or a part 32 connected thereto (for example a driving assistance system) which is designed to execute an automated function (for example object identification based on sensor data from a sensor system, not illustrated, of the motor vehicle 3). The system 1 is designed to execute the method for evaluating a quality of the automated function described below with reference to FIG. 2.

In a first step S1 of the method, multiple self-analysis functions are provided for the automated function, in each case as a software module or collectively as one (single) software module. The self-analysis functions can be transmitted from the backend 2 to the motor vehicle 3, or specifically to the data processing apparatus 31, via the wireless data connection 4, for example.

In a second step S2 of the method, at least one predefined variable is determined in each case based on input data and/or output data of the automated function by means of the self-analysis functions which are executed by the data processing apparatus 31. The input data may be sensor data, for example image data. The output data may be for example the result of an analysis of the sensor data carried out by the automatic function. The predefined variable may be an uncertainty in the case of an association of an object identified by means of a sensor of the motor vehicle with an object track, a frequency of a change of hypothesis in the case of unclear detection of an object identified by means of a sensor of the motor vehicle, a frequency of a change of class of an object identified by means of a sensor of the motor vehicle, and/or an a posteriori measure for an incorrect detection of an object identified by means of a sensor of the motor vehicle. A position of the motor vehicle at which the predefined variables are determined is also defined or determined. In addition, an availability of the automated function at the respective position of motor vehicle 3, that is to say the time at which the predefined variables are determined, and a piece of information about an ODD range of the automated function are also determined.

In a third step S3 of the method, a data vector comprising the predefined variables determined by means of the self-analysis functions, the determined position of the motor vehicle, the availability of the automated function at the time of determination of the position and the predefined variables, and the information about the ODD range of the automated function is determined by the data processing apparatus 31.

In a fourth step S4 of the method, the data vector is transmitted from the motor vehicle 3 to the backend 2.

The steps S1-S4 described above are carried out repeatedly or multiple times by multiple motor vehicles of a motor vehicle fleet to which the motor vehicle 3 belongs, such that the predefined variables and thus the data vector based thereon is determined multiple times at the same position (at different times) and/or in the same driving situation (for example crossing a roundabout) and is transmitted from the respective motor vehicle to the backend 2.

In a fifth step S5 of the method, the multiple data vectors are aggregated in the backend 2. This may be done for example by forming an average value of the variables which are determined and included in the data vectors.

In a sixth step S6 of the method, an existing digital map is created or extended based on the aggregated multiple data vectors.

In a seventh step S7 of the method, the quality of the automated function is evaluated based on predefined criteria by means of the digital map and the automated function is adjusted, for example by extending the ODD range thereof, and/or a further automated function is determined based on a result of the analysis.

The adjusted and/or further automated function can be implemented by means of a software update via the wireless data connection 4 in an eighth step S8 of the method in the motor vehicle 3, in particular the entire motor vehicle fleet to which the motor vehicle 3 belongs.

### LIST OF REFERENCE SIGNS

1 System for data processing
2 Backend
3 Motor vehicle
31 Data processing apparatus
32 Module with automated function
4 Wireless data connection
S1-S8 Method steps

1-10. (canceled)

11. A method for evaluating a quality of an automated function of a motor vehicle, comprising:
providing at least one self-analysis function as a software module for the automated function;
determining, via the self-analysis function, a predefined variable based on input data and/or output data of the automated function; and
transmitting the predefined variable from the motor vehicle to a backend system.

12. The method of claim 11, wherein the predefined variable is:
an uncertainty in the case of an association of an object identified by means of a sensor of the motor vehicle with an object track,
a frequency of a change of hypothesis in the case of an unclear detection of an object identified by means of a sensor of the motor vehicle,
a frequency of a change of class of an object identified by means of a sensor of the motor vehicle, and/or
an a posteriori measure for an incorrect detection of an object identified by means of a sensor of the motor vehicle.

13. The method of claim 11, further comprising:
providing a plurality of self-analysis functions as a software module for the automated function;
determining a respective predefined variable based on the input data and/or the output data of the automated function by means of the self-analysis functions;
determining a data vector from the predefined variables determined by means of the self-analysis functions; and
transmitting the data vector from the motor vehicle to the backend system.

14. The method of claim 11, further comprising:
determining a position of the motor vehicle at which the predefined variable is determined; and
transmitting the determined position, together with the predefined variable, from the motor vehicle to the backend system.

15. The method of claim 11, wherein further comprising:
creating a digital map based on the transmitted predefined variable and the position transmitted together with the predefined variable in the backend.

16. The method of claim 15, further comprising:
obtaining in the backend, via the method steps of claim 11, multiple predefined variables determined at the same position of the motor vehicle and/or in the same driving situation;
aggregating the multiple predefined variables or the multiple data vectors in the backend,
wherein the digital map is created based on the aggregated multiple predefined variables.

17. The method of claim 15, wherein the digital map is created based on an availability of the automated function at the respective position of the motor vehicle and/or a piece of information about an ODD range of the automated function.

18. A data processing system, comprising a means for executing the method of claim 11.

19. A computer program stored on a non-transitory medium and comprising commands which, when executed by a computer, cause the computer to execute the method of claim 11.

20. A non-transitory computer-readable medium comprising commands which, when executed by a computer, cause the computer to execute the method of claim 11.
